(19) United States
(12) Patent Application Publication
(10) Pub. No.: US 2003/0190205 A1
(43) Pub. Date: Oct. 9, 2003

(54) Cutting tool feeding and rotating device for a machine tool

(76) Inventor: Heng-Tsang Yeh, Chang-Hua Hsien (TW)

Correspondence Address: BRINKS HOFER GILSON & LIONE, Suite 3600, NBC Tower, 455 N. Cityfront plaza Drive, Chicago, IL, 60611-5599, US

(21) Appl. No.: 10/167,703

(22) Filed: Jun. 12, 2002

(30) Foreign Application Priority Data
Apr. 9, 2002 (TW) 91204596

(51) Int. Cl. B23C 1/00; B23B 39/10; B23Q 5/32

(52) U.S. Cl. 409/185; 409/231; 408/129

(57) ABSTRACT

A cutting tool feeding and rotating device for a machine tool includes a first mounting frame with a slide way extending in an axial direction. A tubular housing is mounted on and is slidable relative to the slide way in the axial direction. A spindle is received rotatably in the tubular housing and is driven by a drive member which is mounted on a second mounting frame. A servomotor has an output shaft which drives a drive transmission member which can convert a rotational force of the output shaft to a translation force that is exerted on the second mounting frame so as to force the tubular housing together with the second mounting frame to perform a linear displacement in the axial direction.

### BACKGROUND OF THE INVENTION

1. Field of the Invention

This invention relates to a spindle assembly for a machine tool, more particularly to a cutting tool feeding and rotating device for feeding and rotating a cutting tool supported on a spindle during a cutting operation.

2. Description of the Related Art

In a conventional spindle feeding device for a machine tool, such as a CNC machine, oil pressure is generally used to control linear displacement of the spindle. Hence, it is necessary to provide oil inlet and outlet ducts and an oil pressure driving unit in a spindle assembly, thereby resulting in a complicated construction and higher manufacturing costs. In addition, the feeding movement of the spindle will be not accurate due to wearing of the component parts of the device by the oil pressure after prolonged use. Moreover, since the feeding movement of the spindle is constant, it is inconvenient to adjust and set the distance between the spindle and a workpiece.

### SUMMARY OF THE INVENTION

The object of the present invention is to provide a cutting tool feeding and rotating device which can overcome the aforementioned problems commonly associated with the prior art.

According to this invention, the cutting tool feeding and rotating device for a machine tool includes a first mounting frame which has a slide way extending in an axial direction and having front and rear ends opposite to each other in the axial direction. A tubular housing defines a first axis in the axial direction, includes front and rear surrounding portions opposite to each other along the first axis, and has an inner tubular wall surface that confines a through hole which extends along the first axis. The tubular housing is mounted on and is slidable relative to the slide way along the first axis such that the rear surrounding portion extends rearwardly of the rear end. A spindle is received in the through hole, and is rotatable relative the inner tubular wall surface. The spindle includes a front segment which is adapted to grip a cutting tool and which is disposed proximate to the front surrounding portion, and a rear segment which is opposite to the front segment along the first axis and which extends rearwardly and outwardly of the rear surrounding portion. A second mounting frame is connected to the rear surrounding portion. A drive member is mounted on the second mounting frame, and is disposed to drive the rear segment of the spindle to rotate about the first axis relative to the inner tubular wall surface. A servomotor is mounted on the first mounting frame, and has an output shaft extending along a second axis in the axial direction. A drive transmission member is disposed to convert a rotational force delivered by the output shaft to a translation force which is exerted on the second mounting frame such that the tubular housing together with the second mounting frame is forced to perform linear displacement along the first axis.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional schematic view of a preferred embodiment of a cutting tool feeding and rotating device according to this invention;

FIG. 2 is an enlarged sectional view of a portion of the preferred embodiment; and

FIG. 3 is a sectional schematic view of the preferred embodiment during a feeding operation.

### DETAILED DESCRIPTION OF THE PREFERRED EMBODIMENT

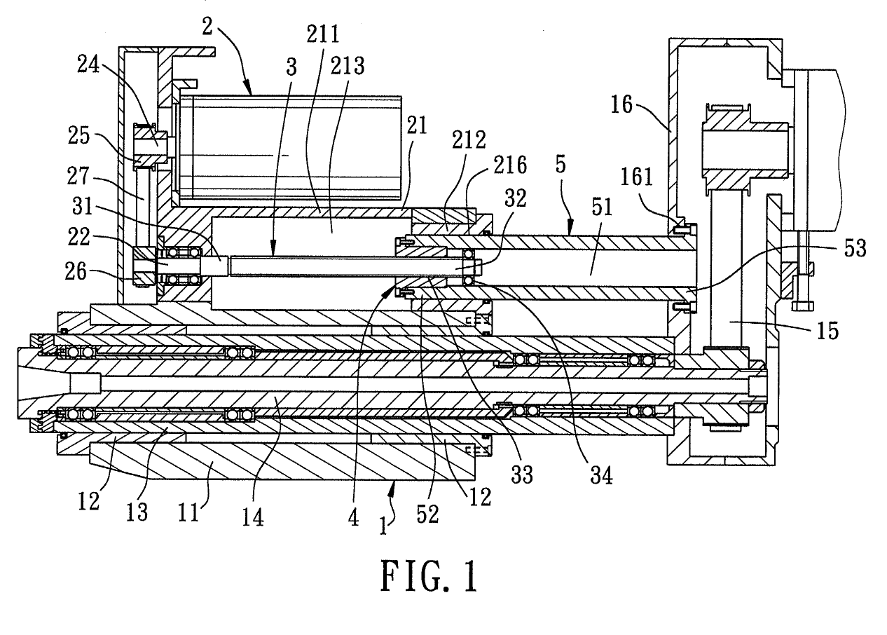

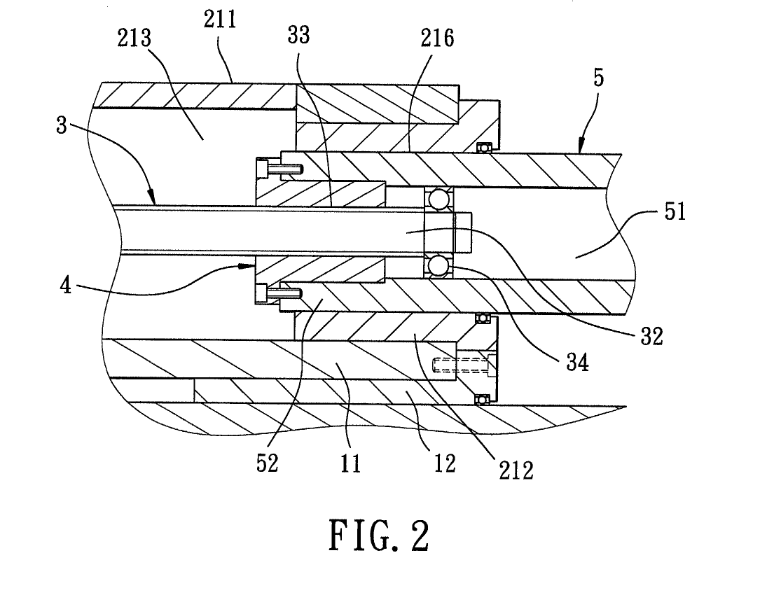

Referring to FIGS. 1 and 2, the preferred embodiment of a cutting tool feeding and rotating device for a machine tool according to the present invention is shown to comprise a first mounting frame 1 which includes a tubular casing 11 and two sleeves 12 inserted into front and rear ends of the tubular casing 11 to confine a slide way therein that extends in an axial direction.

A tubular housing 13 defines a first axis in the axial direction, includes front and rear surrounding portions opposite to each other along the first axis, and has an inner tubular wall surface that confines a through hole which extends along the first axis. The tubular housing 13 is mounted on and is slidable relative to the slide way along the first axis such that the rear surrounding portion extends rearwardly of the rear sleeve 12.

A spindle 14 is received in the through hole, and is rotatable relative the inner tubular wall surface of the tubular housing 13. The spindle 14 includes a front segment which is adapted to grip a cutting tool (not shown) and which is disposed proximate to the front surrounding portion, and a rear segment which is opposite to the front segment along the first axis and which extends rearwardly and outwardly of the rear surrounding portion.

A second mounting frame 16 is secured to the rear surrounding portion of the tubular housing 13.

A drive member 15 is mounted on the second mounting frame 16, and is disposed to drive the rear segment of the spindle 14 to rotate about the first axis relative to the inner tubular wall surface of the tubular housing 13.

A drive transmission member includes a seat 21 which is secured on the first mounting frame 1 and which extends in the axial direction, and a servomotor 2 which is mounted on the seat 21 and which has an output shaft 24 that extends along a second axis in the axial direction. The seat 21 includes a seat body 211 which confines an accommodation space 213, and a tubular sleeve 212 which is secured to the seat body 211 and which has a through hole 216.

A pulley-and-belt mechanism includes a first pulley 25 which is mounted on and which is rotated with the output shaft 24, a second pulley 26 which is mounted on and which is rotated with a driving unit 22, and a belt 27 which is trained on the first and second pulleys 25,26 so as to transmit a rotating force of the output shaft 24 to rotate the driving unit 22 when the servomotor 2 is operated. A driving shaft 3 is received in the accommodation space 213, and has a first shaft end 31 which is coupled to and which is driven by the driving unit 22 to be rotated about a third axis in the axial direction, and a second shaft end 32 which extends rearwardly and along the third axis from the first shaft end 31.

A tubular linear displacement unit 5 has proximate and distal ends 52,53 opposite to each other in the axial direction and respectively proximate to and distal from the second shaft end 32 of the driving shaft 3. The proximate end 52 is received in the through hole 216 and is slidable relative to the sleeve 212. The proximate end 52 has an inner surrounding wall which surrounds the third axis and which confines an insert hole 51. The distal end 53 is secured to the second mounting frame 16 by means of a fastening member 161.

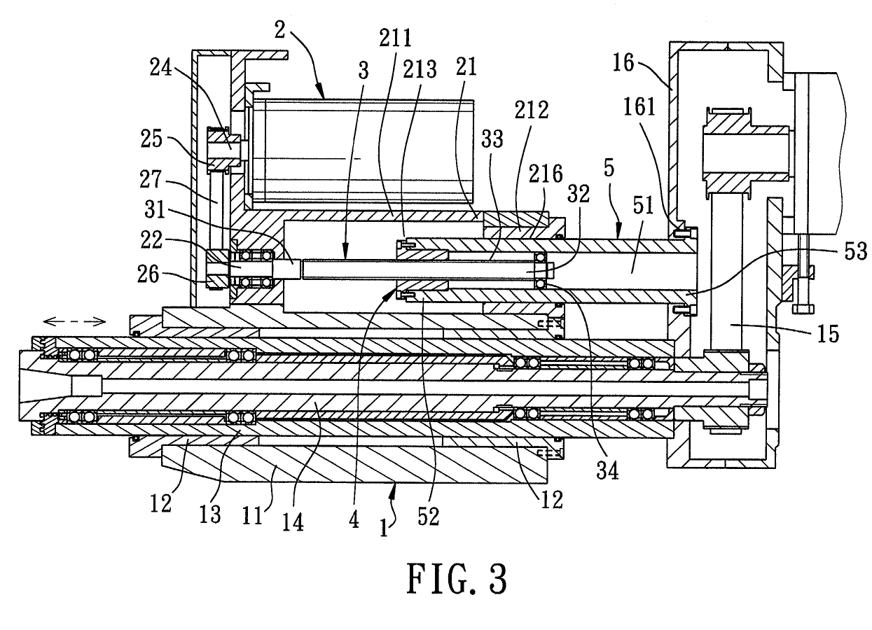

A male and female threaded joint includes a threaded bolt segment 33 which is formed on an outer surrounding wall of the driving shaft 3, and a threaded nut segment 4 which is secured on the inner surrounding wall of the proximate end 52 of the linear displacement unit 5 and which engages threadedly with the threaded bolt segment 33. As such, referring to FIGS. 1 and 3, when the driving shaft 3 is rotated about the third axis, the proximate end 52 on which the threaded nut segment 4 is mounted is moved toward or away from the first shaft end 31 of the driving shaft 3 along the third axis, whereby linear displacement of the tubular housing 13 and the spindle 14 along the first axis can be performed. In addition, a bearing 34 is mounted between the second shaft end 32 of the driving shaft 3 and the inner surrounding wall of the proximate end 52 so as to guide the threaded bolt segment 33 of the driving shaft 3 to move relative to the inner surrounding wall of the proximate end 52.

By virtue of the construction, the cutting tool feeding and rotating device of this invention can achieve the following advantages:

1. As the device of this invention has a simple construction, it can be fabricated at a relatively low cost.

2. The device of this invention does not require an oil pressure driving mechanism used in the aforesaid conventional spindle feeding device.

3. By virtue of the servomotor 2, accuracy of the linear displacing movement of the spindle 14 can be enhanced, and operating errors due to wearing of the threaded bolt segment 33 and the threaded nut segment 4 can be compensated.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A cutting tool feeding and rotating device for a machine tool, comprising:
a first mounting frame including a slide way which extends in an axial direction and which has front and rear ends opposite to each other in the axial direction;
a tubular housing defining a first axis in the axial direction, including front and rear surrounding portions opposite to each other along the first axis, and having an inner tubular wall surface that confines a through hole which extends along the first axis, said tubular housing being mounted on and being slidable relative to said slide way along the first axis such that said rear surrounding portion extends rearwardly of said rear end;
a spindle received in said through hole, and rotatable relative to said inner tubular wall surface, said spindle including a front segment which is adapted to grip a cutting tool and which is disposed proximate to said front surrounding portion, and a rear segment which is opposite to said front segment along the first axis and which extends rearwardly and outwardly of said rear surrounding portion;
a second mounting frame connected to said rear surrounding portion;
a drive member mounted on said second mounting frame, and disposed to drive said rear segment of said spindle to rotate about the first axis relative to said inner tubular wall surface;
a servomotor mounted on said first mounting frame, and having an output shaft extending along a second axis in the axial direction; and
a drive transmission member disposed to convert a rotation force delivered by said output shaft to a translation force which is exerted on said second mounting frame such that said tubular housing together with said second mounting frame is forced to perform linear displacement along the first axis.

2. The cutting tool feeding and rotating device of claim 1, wherein said drive transmission member includes
a driving shaft having a first shaft end which is connected to and which is driven by said output shaft to be rotated about a third axis in the axial direction, and a second shaft end which extends rearwardly and along the third axis from said first shaft end,
a linear displacement unit having proximate and distal ends opposite to each other in the axial direction and respectively proximate to and distal from said second shaft end, said distal end being connected to said second mounting frame, and
a male and female threaded joint disposed between said second shaft end and said proximate end to enable linear displacement of said linear displacement unit along the third axis when said driving shaft is rotated about the third axis.

3. The cutting tool feeding and rotating device of claim 2, wherein said male and female threaded joint includes a threaded bolt segment formed on said second shaft end, and a threaded nut segment disposed on said proximate end and engaging threadedly with said threaded bolt segment such that when said driving shaft is rotated about the third axis, said proximate end is moved toward or away from said first shaft end along the third axis.

4. The cutting tool feeding and rotating device of claim 3, wherein said proximate end is tubular, and has an inner surrounding wall surrounding the third axis and confining an insert hole, said threaded nut segment being secured on said inner surrounding wall, said threaded bolt segment extending into said insert hole, and being configured such that said threaded bolt segment is guided by said inner surrounding wall.

5. The cutting tool feeding and rotating device of claim 2, wherein said drive transmission member further includes a pulley-and-belt mechanism disposed between said output shaft and said first shaft end of said driving shaft so as to transmit a rotating force of said output shaft to rotate said driving shaft when said servomotor is operated.
